(19) United States
(12) Patent Application Publication
(10) Pub. No.: US 2004/0026264 A1
(43) Pub. Date: Feb. 12, 2004

(54) Evaporative cooler water conditioner

(76) Inventor: James L. Boden, Grand Junction, CO (US)

Correspondence Address: JAMES L. BODEN, 2801 COTTAGE LANE, GRAND JUNCTION, CO, 81506, US

(21) Appl. No.: 10/103,271

(22) Filed: Aug. 6, 2002

(51) Int. Cl. C02F 1/461

(52) U.S. Cl. 205/745; 204/248

(57) ABSTRACT

A device for killing bacteria and algae in the water reservoir of an evaporative cooler. The water conditioner kills bacteria and limits algae growth by inducing a DC current on the water itself. The interaction of a zinc disk and a copper ring encircling it produces a small voltage (approximately 4-6 volts and a current in the milliamp range). The zinc acts as an anode, and the copper ring acts as a cathode. Assembly posts and end pieces act as supports and also as an insulator between the two metals of the assembly and the metal parts of the evaporative cooler. By killing bacteria present in the water and limiting the growth of algae, the water conditioner eliminates foul odors, controls rust and corrosion, and maintains the freshness of the water over long periods of time, thereby ensuring greater indoor air quality when the evaporative cooler is operated.

### CROSS REFERENCE TO RELATED APPLICATIONS

NOT APPLICABLE

### FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISK APPENDIX

NOT APPLICABLE

### BACKGROUND OF INVENTION

Evaporative coolers (swamp coolers) have been in use for years. They simply use the evaporative cooling effect of hot air passing over wet pads constructed of man made materials or aspen to drop the temperature of the air passing through them to cool inside living and working spaces in structures.

One of the biggest problems with evaporative coolers is the fact that they are idle at times under high temperature conditions, i.e. the water in the reservoir is going to warm up at some point, (usually when the cooler is turned off and not used for some time).

It is at this time that the water temperature increases to the point that algae and bacterial growth occur. Eventually enough growth is present to produce a slime coat on the cooler parts, bacterial and algae growth on the cooler pads, and a foul odor like sulphur, (hence the name “swamp cooler”).

I have invented a means of controlling or eliminating bacterial/algae growth by using a disk of zinc metal contained in a nylon body, which interacts with a copper ring. The interaction of the two dissimilar metals when immersed in water produces a DC voltage of approximately 4.5-6 volts in the milliampere range when measured between the zinc disk and the copper ring.

The introduction of an electrical charge to the water inhibits the growth of bacterial and algae thereby eliminating the odor associated with them. It also inhibits and controls the formation of scale and other hard water deposits, which can foul the pump, pads, and also deteriorate the body of the cooler itself through rust and corrosion.

Over time the zinc acts as a sacrificial anode, but unlike other anodes that are grounded to the frame of the cooler (producing no voltage), my invention insulates the zinc and copper from the cooler body and each other by using a nylon cage.

### SUMMARY OF INVENTION

As stated my evaporative cooler water treatment device solves many problems associated with evaporative coolers, by introducing an electrical charge on the water in the pan of the cooler it inhibits growth of bacteria and algae, limits corrosion, rust and scale build up. It eliminates the need for frequent draining and refilling of the cooler, bleed-off kits, and chemicals. Odors are eliminated, it is completely harmless, and it improves the quality of the air introduced into cooled spaces creating a much more pleasant atmosphere. It controls or eliminates the growth of bacteria and algae, spores, etc. which would be beneficial for persons suffering from allergies.

### BRIEF DESCRIPTION OF DRAWING VIEWS

In FIG. 1 a zinc disk is held in place with a retainer made of nylon material, the pins not only hold the zinc in place, but they also provide a means of providing the proper gap which separates the zinc and a copper ring.

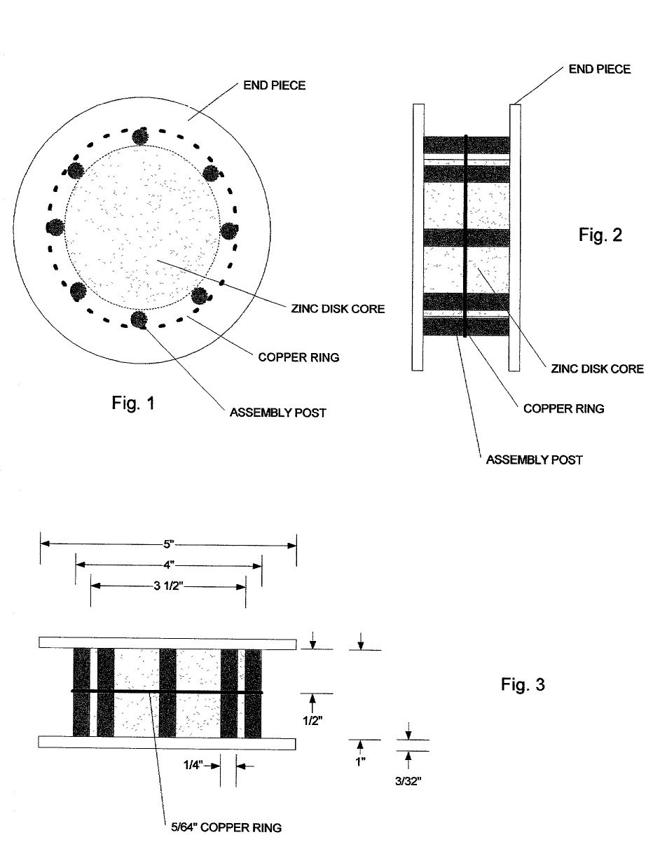

In FIG. 2 a second retainer is fitted over the first holding the zinc disk securely in place.

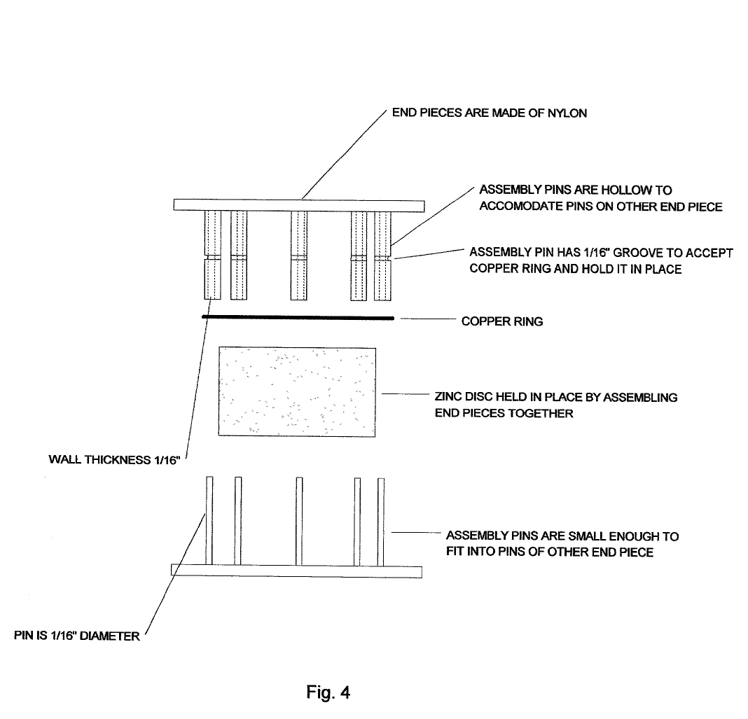

In FIG. 4 a simple assembly of the invention is shown.

### DETAILED DESCRIPTION OF INVENTION

The manufacture of the device is quite simple, the end pieces are injection molded and made of nylon, both pieces interlock and form a cage which holds a disk of zinc. A copper ring is added to one end of the cage and is held in place by a groove; the pins of the interlocking pieces hold the copper ring in place and also isolate the two metals. The distance between the metals lets them interact and create a voltage of approximately 4-6 volts DC, which charges the water, killing bacteria and algae.

The nylon cage also insulates both metals from contact with the metal parts of the cooler which would “short out”, or ground the metals which would result in a “zero” voltage state. To use my invention one would simply place it in the water in the tray of the cooler completely immersing it.

My invention is completely different from other conventional anode systems in use by virtue of the fact that a conventional anode does not produce a substantial electrical charge since it is grounded to the metal of the cooler. It is impossible for a conventional anode to have an effect on bacteria and algae; my invention not only addresses those problems but acts as a conventional anode as well and inhibits rust and corrosion.

1. It is my claim that my use of an insulating material in conjunction with two dissimilar metals in a conductive media (water) to produce an electrical charge to specifically inhibit and kill bacteria and algae is a unique and new method previously unheard of it is much more effective than old style sacrificial anodes, and most likely will have more applications such as the treatment of municipal water supplies, swimming pools, spas, hot tubs, hot water heaters, dehumidifiers, condensate trays, and portable water treatment devices used in camping and backpacking applications.
